(19) United States
(12) Patent Application Publication
(10) Pub. No.: US 2025/0334505 A1
(43) Pub. Date: Oct. 30, 2025

(54) METHOD FOR EVALUATING CORROSION RESISTANCE OF THERMAL SPRAY COATING

(71) Applicant: SK INNOVATION CO., LTD., Seoul (KR)

(72) Inventors: Seong Hoon JEONG, Daejeon (KR); Hyun Joon PARK, Daejeon (KR)

(21) Appl. No.: 19/078,279

(22) Filed: Mar. 13, 2025

(30) Foreign Application Priority Data
Apr. 25, 2024 (KR) 10-2024-0055566

(51) Int. Cl. G01N 17/00; C23C 4/01; C23C 4/12

(52) U.S. Cl. CPC G01N 17/00; C23C 4/01; C23C 4/12

(57) ABSTRACT

A method for evaluating corrosion resistance of a thermal spray coating, the method including (a) coating one or more sides of a sample by a thermal spray coating method to form a thermal spray coated sample; (b) immersing the thermal spray coated sample in an acid solution; and (c) analyzing the components of the acid solution by collecting the acid solution at regular intervals after immersion. The analysis is performed by an inductively coupled plasma (ICP) analysis method. Based on the method, accuracy of evaluating the corrosion resistance of the thermal spray coating can be improved, and the method of evaluating the corrosion resistance of the thermal spray coating can be simplified.

### CROSS REFERENCE TO RELATED APPLICATION

The present application claims priority to Korean Patent Application No. 10-2024-0055566, filed Apr. 25, 2024, the entire contents of which are incorporated herein for all purposes by this reference.

### BACKGROUND OF THE DISCLOSURE

### 1. Field of the Disclosure

The embodiments of the present disclosure relate generally to surface thermal treatment technologies and more specifically to a method for evaluating corrosion resistance of thermal spray coating.

### 2. Description of the Related Art

Thermal spray coating is a surface treatment technique which is applied to enhance the performance of a coated material. The thermal spray coating method is mainly applied to ensure corrosion resistance and to extend the lifespan and integrity of parts operating in an acidic environment. Examples of such parts may include roll equipment used in printing, papermaking, and separator manufacturing; semiconductor manufacturing equipment; and heat exchange equipment in alkylation processes.

However, performance of a coating applied by the thermal spray coating method shows significantly large differences depending on the particular method used and the process conditions even when the same coating material is used. Thus, when applying coating to various parts of a device, process equipment or an article of manufacture, there is a possibility that the performance of a coating may not be improved to the desired level, or that the integrity of the parts may be damaged due to peeling of the coating layer.

### SUMMARY OF THE DISCLOSURE

According to an embodiment of the present disclosure, a method can be provided for accurately evaluating corrosion resistance of a thermal spray coating after long-term exposure to an acid solution.

According to an embodiment of the present disclosure, a method for evaluating corrosion resistance of a thermal spray coating is provided. The method includes (a) coating one or more sides of a sample by a thermal spray coating method to form a thermal spray coated sample; (b) immersing the thermal spray coated sample in an acid solution; and (c) analyzing components of the acid solution by collecting the acid solution at regular intervals after the immersion. Herein, the analysis is performed by an inductively coupled plasma (ICP) analysis method.

In an embodiment, the thermal spray coating method may include flame spraying, arc thermal spraying, plasma spraying, high velocity oxy-fuel (HVOF), low-temperature spraying, or a combination thereof.

In another embodiment, the coating may include forming a thermal spray coating of the thermal spray coated sample to a thickness of 10 to 3000 μm.

In a further embodiment, the method may further include masking a non-spray coated edge region of the thermal spray coated sample between the operations (a) and (b).

In a yet further embodiment, the masking may be performed using polytetrafluoroethylene (PTFE) as a masking material.

In a still yet further embodiment, the acid solution may include a sulfuric acid, a hydrochloric acid, a nitric acid, or a combination thereof.

In a still yet further embodiment, the immersing may be performed for 10 to 30 days.

In a still yet further embodiment, the regular intervals may be 24 hours.

In a still yet further embodiment, the analysis may be performed by comparing contents of components from the thermal spray coated sample among the components of the acid solution measured by the ICP analysis method.

According to an embodiment of the present disclosure, corrosion resistance of a thermal spray coating can be evaluated without separate pre-treatment of a thermal spray coated sample. High accuracy in corrosion resistance evaluation as described above can also be achieved.

These and other features and advantages of the embodiments of the present disclosure will become better understood by those with ordinary skill in the art from the following figures and the detailed description.

### BRIEF DESCRIPTION OF THE DRAWINGS

FIG. 1 shows a schematic diagram of a method for evaluating corrosion resistance of thermal spray coated samples according to one embodiment of the present disclosure;

FIGS. 2 and 3 show scanning electron microscope (SEM) images showing microstructures of coating layers after evaluating the corrosion resistance of the thermal spray coated samples according to another embodiment of the present disclosure;

FIG. 4 shows a schematic diagram of a method for evaluating the corrosion resistance of the thermal spray coated samples according to a further embodiment of the present disclosure; and

FIGS. 5A to 5C show images showing corrosion degree of the thermal spray coated samples after immersion in an acid solution for 11 days according to a yet further embodiment of the present disclosure.

### DETAILED DESCRIPTION

Hereinafter, the embodiments of the present disclosure will be described in detail with reference to the attached drawings. However, this is merely illustrative and the embodiments are not limited to the specific embodiments described.

According to an embodiment of the present disclosure, a method for evaluating corrosion resistance of a thermal spray coating is provided. The method includes (a) coating one or more sides of a sample by a thermal spray coating method to form a thermal spray coated sample; (b) immersing the thermal spray coated sample in an acid solution; and (c) analyzing components of the acid solution by collecting the acid solution at regular intervals after immersion. Herein, the analysis is performed by an inductively coupled plasma (ICP) analysis method.

The coating of one or more sides of a sample by a thermal spray coating method to form a thermal spray coated sample (operation a) refers to applying a thermal spray coating to a sample surface to form a thermal spray coated sample that is the subject of corrosion resistance evaluation. The thermal spray coating method is a coating method in which a wired or powdered thermal spray material is melted in a high-temperature heat source and then is ejected through a high-speed gas flow to accumulate on a surface of a target sample. The high-temperature and high-speed molten spray material collides with and spreads on the surface of a relatively low-temperature sample with a predetermined level of surface roughness. As a result, the molten spray material cools rapidly and its temperature reaches room temperature. Then, coating bonding is achieved through mechanical bonding which is made in a meshing phenomenon occurring at collision surfaces between thermal spray material particles and the sample surface and between the thermal spray material particles, and/or metallurgical bonding by partial melting and diffusion. Based on the principles described above, the thermal spray material is applied to the sample surface to form a thermal spray coated sample.

In an embodiment, the thermal spray coating method may include flame spraying, arc thermal spraying, plasma spraying, high velocity oxy-fuel (HVOF), low-temperature spraying, or a combination thereof. The flame spraying refers to a method of spray coating a sample surface by melting a ceramic spray material using an oxygen acetylene salt at 2000° C. or higher. The arc thermal spraying refers to a method in which arc heat is generated between the tips of two metal wires to melt the metal wires, and then the tips of the molten metal wires are sprayed with a jet of compressed air, allowing the tips to collide with a sample surface for lamination. The plasma spraying refers to a method of spray coating a sample surface by melting a powdered spray material using a plasma jet. The HVOF refers to a method of spray coating a sample surface by melting a powdered thermal spray material and ejecting it at a speed of sound using liquid or gas as fuel. The low-temperature spraying refers to a method of coating a powdered spray material by colliding the powdered spray material with a sample surface using a kinetic energy of a high-speed gas flow at a low temperature close to room temperature. As described above, the method for evaluating corrosion resistance of a thermal spray coating of the present disclosure may be applied without limitations on thermal spray materials and thermal spray coating methods applied to a thermal spray coated sample.

In another embodiment, the coating may include forming a thermal spray coating of the thermal spray coated sample to a thickness of 10 to 3000 μm. The method for evaluating corrosion resistance of a thermal spray coating of the present disclosure involves evaluating corrosion resistance of a coating after exposure of a coated sample to an acid solution for a long period of time compared to conventional methods for evaluating coating corrosion resistance. Accordingly, the method of the present disclosure may further increase accuracy of the corrosion resistance evaluation. When the thermal spray coating of a thermal spray coated sample is formed to a thickness of less than 10 μm, the entire thermal spray coating may corrode when the coated sample is exposed to an acid solution for a week or longer, and even the sample inside the spray-coating may be corroded by the acid solution. In this case, the accuracy of the corrosion resistance evaluation of the thermal spray coating itself may be reduced when obtained through a component analysis of the acid solution. When the thermal spray coating of the thermal spray coated sample is formed to a thickness of more than 3000 μm, it may be disadvantageous in terms of cost because the coating thickness excessively exceeds a coating thickness required to evaluate the corrosion resistance of the thermal spray coating after long-term exposure of the coated sample to the acid solution. Additionally, a problem such as delamination of the outermost portion of the coating may occur. Therefore, the accuracy of the corrosion resistance evaluation may also be reduced. In a further embodiment, the coating may involve forming a thermal spray coating of the thermal spray coated sample to a thickness of preferably 50 to 2000 μm, more preferably 100 to 1000 μm.

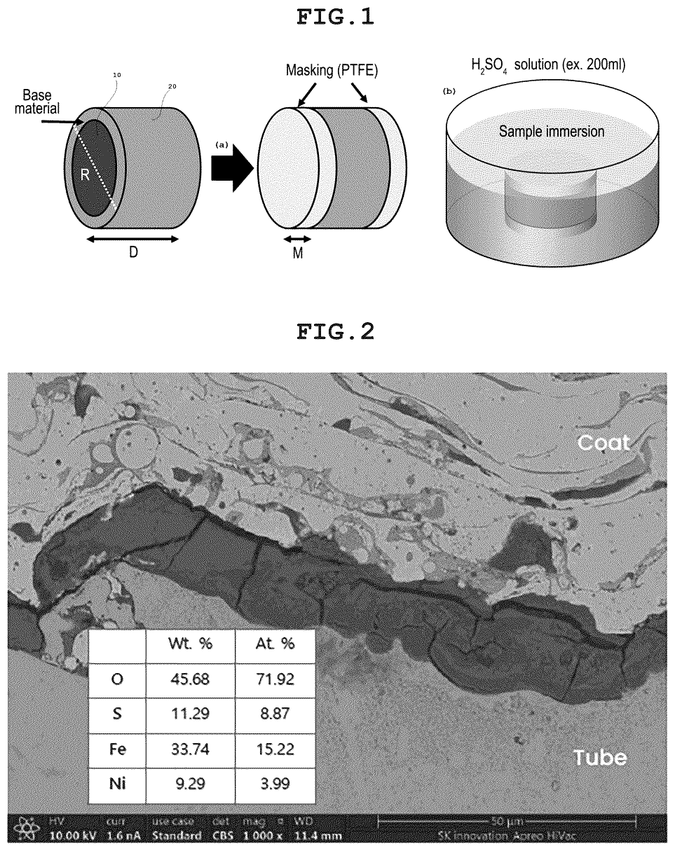

In a yet further embodiment, the method may further include masking a non-spray coated edge region of the thermal spray coated sample between the operations (a) and (b). As shown in FIG. 1, the masking means covering the non-spray coated edge region of the thermal spray coated sample with another material, that is, the non-spray coated edge region means a sample surface that may be exposed to an acid solution when the thermal spray coated sample is immersed in the acid solution. Since the masking material should not affect the corrosion resistance evaluation results of the thermal spray coating, the masking material is required to be a material that has corrosion resistance to acids. So, by masking, the portion of the thermal spray coated sample corroded by the acid solution is limited to the spray coated portion.

For example, as shown in FIG. 1, the masking may be performed using polytetrafluoroethylene (PTFE) as a masking material. There are no limitations on the masking material as long as the masking material has corrosion resistance to acids and does not corrode at all when immersed in an acid solution. The PTFE does not dissolve or corrode not only in acids but also in alkalis and almost all other solvents, so the PTFE may be used as a masking material in the masking.

The method includes immersing the thermal spray coated sample in an acid solution (operation b). As described above, when the thermal spray coated sample is immersed in an acid solution, the only portion that is reactive to the acid solution is the spray coated portion. The spray-coated portion is immersed in the acid solution and dissolves in the acid solution over time.

In a still yet further embodiment, the acid solution may include a sulfuric acid, a hydrochloric acid, a nitric acid, or a combination thereof. The corrosion resistance evaluation of a thermal spray coating of the present disclosure is to evaluate whether the thermal spray coating has corrosion resistance to strong acids. The acid solution used for this is required to have a strong acidity that can dissolve the components of the thermal spray coating to a detectable degree. From this perspective, the acid solution used for evaluating the corrosion resistance of a thermal spray coating of the present disclosure may include acids corresponding to strong acids, such as a sulfuric acid, a hydrochloric acid, and a nitric acid. Specifically, the acid solution may be an acid solution having a strong acid concentration of 40 to 90 wt %, preferably 45 to 90 wt %, and more preferably 50 to 85 wt %.

In a still yet further embodiment, the immersing may be performed for 10 to 30 days. As described above, the corrosion resistance evaluation of a thermal spray coating of the present disclosure is conducted after exposure of a coated sample to an acid solution for a longer period of time compared to the conventional methods for evaluating corrosion resistance of a coating. This may increase the accuracy of corrosion resistance evaluation compared to the corrosion resistance evaluation of a thermal spray coating after exposure of a coated sample to an acid solution over a short period of time. When the immersing is performed for less than 10 days, the corrosion resistance of a thermal spray coating is evaluated in a state where a reaction between the acid solution and the thermal spray coating is not completed, and the accuracy of the evaluation results may be low. When the immersing is performed for more than 30 days, the spray-coated portion may become excessively corroded, and a portion of the sample inside the spray-coating may also contact the acid solution, causing some components of the sample to be dissolved in the acid solution. Some components of the dissolved sample may act as noise in the corrosion resistance evaluation of the thermal spray coating and reduce the accuracy. In a still yet further embodiment, the immersing may be performed for 11 to 25 days, more specifically 12 to 20 days.

The method includes analyzing components of the acid solution by collecting the acid solution at regular intervals after the immersion (operation c). Herein, the analysis is performed by an inductively coupled plasma (ICP) analysis method. As described above, when a thermal spray coated sample is immersed in an acid solution, the portion of the thermal spray coating exposed to the acid solution is corroded by the acid solution, and the corroded components of the thermal spray coating are dissolved in the acid solution. By collecting the acid solution at regular intervals and analyzing the components in the acid solution by the ICP analysis, the type and amount of components of the corroded thermal spray coating in the acid solution as described above may be specified. Herein, the ICP analysis method is performed by flowing an inert gas such as argon along the axis of a high-frequency coil, raising a temperature of the inert gas to an extremely high temperature of 6000 K or more to generate a plasma, and injecting an acid solution, which is in a liquid state, in the form of particles. Atoms of the injected acid solution are excited by the plasma, and as the excited atoms return to the ground state, light is emitted. The light emitted in this way is analyzed through a spectroscopy. In this case, it is possible to detect the type and amount of components in the acid solution. In this way, the corrosion resistance evaluation of a thermal spray coating of the present disclosure is performed on the acid solution collected after immersing the thermal spray coated sample in the acid solution. It does not cause porosity of non-uniform thermal spray coating and not require a pre-treatment process to uniform a microstructure, unlike a method of evaluating corrosion resistance which is performed by measuring an area of rust generated on a thermal spray coated sample after immersion in an acid solution. Thus, the evaluation of the present disclosure is beneficial. The collecting and analyzing of the acid solution are performed at regular intervals after immersing the thermal spray coated sample in the acid solution, so it is possible to accurately determine the corrosion degree of the thermal spray coating over time. By confirming the presence of components derived from the thermal spray coated sample, not from the thermal spray coating, by the ICP analysis method, it is possible to determine whether the coating is damaged.

In a still yet further embodiment, the regular intervals may be 24 hours. As described above, the corrosion resistance evaluation of a thermal spray coating of the present disclosure may include immersing the thermal spray coated sample in an acid solution for a long period of time to improve accuracy compared to a conventional corrosion resistance evaluation of a coating. During the immersion, the acid solution is collected at regular intervals and the components of the acid solution are analyzed to confirm the corrosion degree of and damage to the thermal spray coating over time. There are no limitations to the cycle length of the acid solution collection as long as the cycle length is constant. For example, the cycle of acid solution collection may be 1 hour, 2 hours, 3 hours, 4 hours, 5 hours, 6 hours, 8 hours, 10 hours, 12 hours, 24 hours, 2 days (48 hours), 3 days (72 hours), or 1 week (168 hours). The cycle of acid solution collection is preferably 24 hours from the viewpoint of convenience of process control.

In a still yet further embodiment, the analysis may be performed by comparing contents of components from the thermal spray coated sample among the components of the acid solution measured by the ICP analysis method. Among the components of the acid solution measured by the ICP analysis method, the presence of the components derived from the thermal spray coated sample, for example, more broadly, the presence of components of the thermal spray coating itself and/or the presence of components derived from the thermal spray coated base material (sample) may serve as an indicator that the thermal spray coating of the thermal spray coated sample and/or the base material itself inside the thermal spray coating have been corroded. For example, among the contents of components measured by the ICP analysis method with the acid solution in which various thermal spray coated samples are immersed, when high contents of components derived from the thermal spray coating and high contents of components derived from the base materials (samples) are shown, it means low corrosion resistance of the thermal spray coating. This may be evaluated as corrosion of the base materials inside the coating. On the other hand, when the contents of components derived from the thermal spray coating are measured to be low but the contents of components derived from the base materials are measured to be high, the thermal spray coating for the sample has high corrosion resistance but low peeling resistance. This may be evaluated as the coating not sufficiently protecting its base material.

Hereinafter, embodiments of the present disclosure will be further described with reference to specific experimental examples. The examples and comparative examples included in the experimental examples only illustrate the embodiments of the present disclosure and do not limit the scope of the appended claims. It is apparent to those skilled in the art that various changes and modifications to the embodiments are possible within the scope and spirit of the present disclosure. Such changes and modifications naturally fall within the scope of the appended claims. Furthermore, the embodiments may be combined to form additional embodiments.

### Experimental Example 1—Corrosion Resistance Evaluation of C-276 Thermal Spray Coating

As shown in FIG. 1, a thermal spray-coating with C-276 indicated with numeral 20 and having a composition of Ni-16Mo-16Cr-5Fe-4W as a thermal spray material was applied to the outer circumferential surface of three tube-formed carbon steel samples referred to as base material and indicated with numeral 10, having a composition of Fe-0.4Mn-0.1C. Herein, the two end faces of the tube-formed samples were excluded from the coating. As a result, three thermal spray coated samples (Samples 1 to 3) were obtained. When preparing the three thermal spray coated samples, thermal spray coatings of the same thickness and the same thermal spray material were applied using a random coating method by different thermal spray coating companies. Thereafter, the two non-spray-coated end faces of each of the three thermal spray coated samples were masked with PTFE as shown in FIG. 1. The three masked thermal spray coated samples were immersed in 200 mL of H₂SO₄ solution with a concentration of 60% by volume for 4 weeks (see Operation (b) in FIG. 1). The H₂SO₄ solution was collected every 1 week (168 hours), and an ICP spectroscopic analysis method was performed. Through this, the contents of Cr, Fe, Ni, and Mo (% by weight, Total) and the proportion of Fe (% by weight, Fe %) in the collected H₂SO₄ solution were measured. The measurement results are shown in Table 1 below.

TABLE 1

| ICP data (ppm) | Week | Cr | Fe | Ni | Mo | Total | Fe % |
|---|---|---|---|---|---|---|---|
| Sample 1 | 1 | 2 | 109 | 1358 | 124 | 1620 | 5.7 |
| | 2 | 4 | 265 | 1737 | 163 | 2169 | 12.2 |
| | 4 | 7 | 676 | 2394 | 229 | 3306 | 20.4 |
| Sample 2 | 1 | 5 | 28 | 193 | 20 | 246 | 11.4 |
| | 2 | 8 | 67 | 279 | 33 | 387 | 17.3 |
| | 4 | 15 | 153 | 373 | 49 | 590 | 25.9 |
| Sample 3 | 1 | 2 | 1 | 15 | 2 | 19 | 5.0 |
| | 2 | 4 | 3 | 31 | 4 | 42 | 7.1 |
| | 4 | 13 | 7 | 108 | 20 | 149 | 4.7 |

As a result of the measurements, a total of 3306 ppm was detected in the H₂SO₄ solution collected after immersing Sample 1 in the H₂SO₄ solution for 4 weeks, and a total of 590 ppm of Cr, Fe, Ni, and Mo in sample 2, and a total of 149 ppm in sample 3. From this, it was confirmed that the corrosion resistance of the thermal spray coatings occurred in the order of Sample 3>Sample 2>Sample 1. In particular, in Sample 1, the amount of Ni detected over time was higher than in Sample 2. Considering that Ni was the main component of the C-276 thermal spray material, it was inferred that the corrosion degree of the coating in Sample 1 was significantly greater than that in Sample 2.

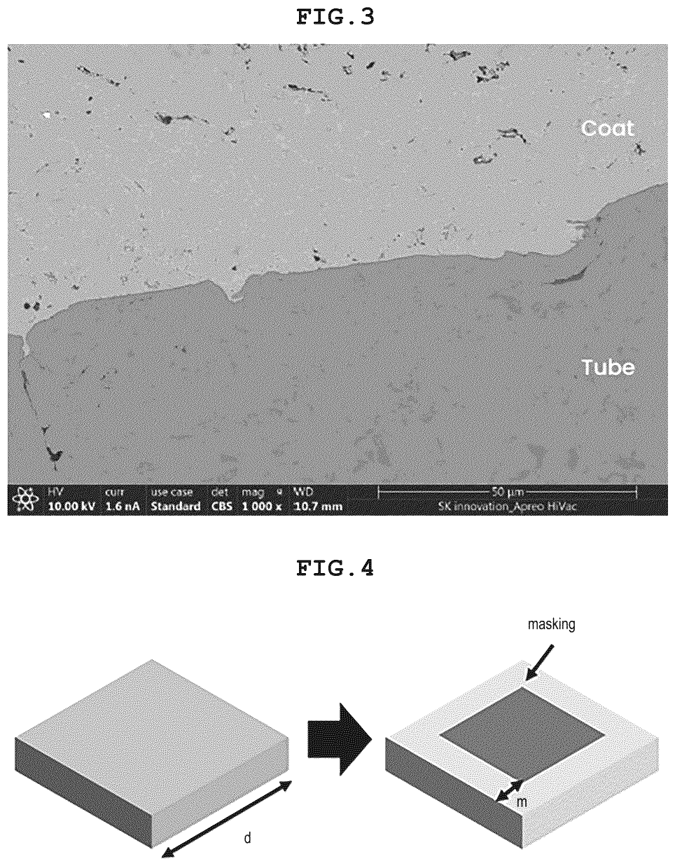

The Fe % value was shown in the order of sample 3<sample 1<sample 2. This value represented the degree to which a sample (base material) containing about 5% by weight of Fe was dissolved in the H₂SO₄ solution. When the Fe % in the H₂SO₄ solution exceeded 5% by weight, it was inferred that the thermal spray coating was damaged, and corrosion of the base material itself was progressing. In Samples 1 and 2, where the Fe % was excessively higher than 5% by weight, it was determined that the thermal spray coatings were damaged and corrosion of the base material itself was progressing in the samples. In contrast, Sample 3, which did not show a higher Fe % than the 5% by weight, had little or no damage to the base material. This was confirmed more clearly through a comparison of FIGS. 2 and 3. FIGS. 2 and 3 are SEM images of the microstructures of the coating layer interfaces after the immersion of Samples 1 and 3 in the H₂SO₄ solution for 4 weeks, respectively. In FIG. 2, a dark-colored corrosion product was observed between the base material (Tube) and the thermal spray coating (Coat), whereas in FIG. 3, no corrosion product was confirmed at the interface. Although the samples were obtained using the same base material and the same thermal spray material, Sample 1 to Sample 3 showed different corrosion resistance. This was believed to be due to thermal spray coating process variables such as the thermal spray coating method and/or current, voltage, pneumatic pressure, coating environment (humidity), and coating surface modification status.

Through the method of evaluating corrosion resistance of a thermal spray coating described above, it was possible to identify a sample showing better corrosion resistance among samples of the same base material and thermal spray material.

### Experimental Example 2—Corrosion Resistance Evaluation of WC—Co and WC—CrC—Ni Thermal Spray Coatings

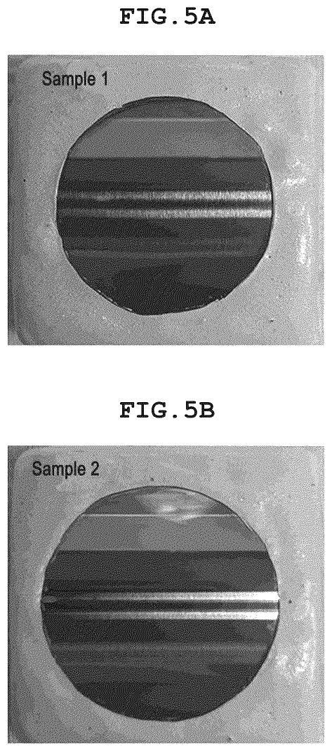

As shown in FIG. 4, three plate-formed carbon steel samples (base materials) were prepared. Among the three plate-formed carbon steel samples, a WC—Co thermal spray material was spray-coated on the top and bottom surfaces of one sample in a random manner. Then, the four sides of the uncoated sample were masked with PTFE (Sample 1). A WC—CrC—Ni thermal spray material was spray-coated on the top and bottom surfaces of the remaining two samples in a random manner. Then, the four sides of the uncoated samples were masked with PTFE (Samples 2 and 3). Samples 1 to 3 were each thermally spray coated by different thermal spray coating companies using a random coating method. The thermal spray coating thickness of these three samples was all the same. Thereafter, Samples 1 to 3 were immersed in a hydrochloric acid solution for 11 days, respectively. The hydrochloric acid solution for each case was collected every 24 hours, and the amount of Fe (mg) in the collected hydrochloric acid solution was measured by an ICP spectroscopic analysis method. The measurement results are shown in Table 2 below.

TABLE 2

| ICP data* | | | Diss. rate |
|---|---|---|---|
| (ppm) | Day | Fe | (mg/cm²) |
| Sample 1 | 1 | 112 | 3.6 |
| | 4 | 574 | 18.3 |
| | 11 | 1228 | 39.1 |
| Sample 2 | 1 | 8 | 0.2 |
| | 4 | 57 | 1.8 |
| | 11 | 386 | 12.3 |
| Sample 3 | 1 | 1 | 0.0 |
| | 4 | 32 | 1.0 |
| | 11 | 1220 | 38.8 |

Referring to Table 2, 112 mg or more of Fe was eluted from Sample 1 after 1 day (24 hours) of the immersion of the samples in the HCl solution, confirming that the thermal spray coating of Sample 1 had the lowest corrosion resistance.

The amount of Fe eluted was relatively small until 11 days after the immersion of the samples in the HCl solution, confirming that Sample 2 had the most excellent corrosion resistance.

Sample 3 had the lowest amount of Fe eluted until 4 days after its immersion in the HCl solution, but the amount of Fe eluted rapidly increased after 11 days. It was confirmed that Sample 3 was not corroded by short-term exposure to the acid solution, but was vulnerable to relatively long-term exposure to the acid solution.

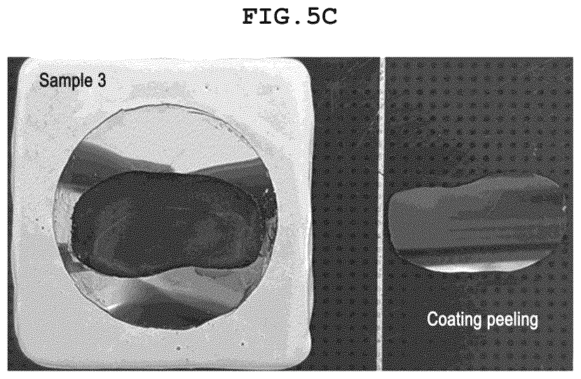

FIGS. 5A to 5C are images showing visual appearances of Samples 1 to 3 when observed with the naked eye, respectively, after the immersion of the samples in the HCl solution for 11 days.

Among these, when comparing Samples 2 and 3, spray coated with the same thermal spray material of WC—CrC—Ni, did not contain Fe. As a result, it could be inferred that all Fe detected for Samples 2 and 3 in Table 2 originated from each of their base materials.

Referring to Table 2, when the corrosion experiments were conducted, only a trace amount of corrosion occurred in both Samples 2 and 3 after the immersion for 4 days (96 hours). From this, it was confirmed that the coatings of samples 2 and 3 both had good corrosion resistance when exposed to the acid solution for a short period of time. However, when the immersion was conducted for 11 days (264 hours), the amount of Fe detected in Sample 3 became very high. This was presumed to be because as the exposure time to the acid solution increased, the coating layer of Sample 3 peeled off and the internal base material was directly exposed to the hydrochloric acid solution.

As a criterion for judging the performance and effectiveness of the coating, the degree to which the coating remains stable from external stress and/or impact, or a bond strength between the base material and the coating may also be considered in addition to the degree to which the base material is protected from exposure to an acid solution. In this respect, it could be inferred that Samples 2 and 3 appeared to have equivalent performance of a coating in protecting the base material from exposure to the acid solution, but the thermal spray coating of Sample 3 was weak in its own physical properties and bonding strength, so even a small amount of internal corrosion caused the coating layer of Sample 3 to be easily peeled off from the base material, leading to damage or detachment.

Typically, to confirm the exact physical properties of the coating and the bonding strength to the base material, data is required to be comprehensively analyzed through various experiments. However, in the embodiments of the present disclosure, the effectiveness of the composite coatings could be verified through simpler corrosion experiments and ICP analysis method.

Referring to FIGS. 5A and 5B, it appeared that no corrosion occurred in Samples 1 and 2. However, as shown in Table 2, the amount of Fe detected in Sample 1 and Sample 2 are significantly different. From this, it could be confirmed that, based on the ICP measurement value after the immersion of the samples for 11 days (264 hours), the amount of Fe detected in Sample 1 was similar to the amount of Fe detected in Sample 3, where internal corrosion occurred as described above. The amount of Fe detected in Sample 3 after the 11 days was due to direct corrosion of the base material caused by the peeling of the coating layer during the experiment. Given that, in the case of Sample 1, it was inferred that the shape of the coating layer was maintained well regardless of internal corrosion, but in reality, the performance of the coating in protecting the base material from the external environment was significantly low.

As described above, the ICP analysis method of the present disclosure was significant in that it provided data that could be used to infer the performance of the coating, which was difficult to confirm when observing the samples with the naked eye.

The embodiments described above are merely an illustration of applying the principles of the present disclosure, and other embodiments may be further included without departing from the scope of the present disclosure.

What is claimed is:

1. A method for evaluating corrosion resistance of thermal spray coating, the method comprising:
(a) coating one or more sides of a sample by a thermal spray coating method to form a thermal spray coated sample;
(b) immersing the thermal spray coated sample in an acid solution; and
(c) analyzing components of the acid solution by collecting the acid solution at regular intervals after the immersion,
wherein the analysis is performed by an inductively coupled plasma (ICP) analysis method.

2. The method of claim 1, wherein the thermal spray coating method comprises flame spraying, arc thermal spraying, plasma spraying, high velocity oxy-fuel (HVOF), low-temperature spraying, or a combination thereof.

3. The method of claim 1, wherein the coating comprises forming a thermal spray coating of the thermal spray coated sample to a thickness of 10 to 3000 μm.

4. The method of claim 1, further comprising:
masking a non-spray coated edge region of the thermal spray coated sample between the operations (a) and (b).

5. The method of claim 4, wherein the masking is performed using polytetrafluoroethylene (PTFE) as a masking material.

6. The method of claim 1, wherein the acid solution comprises a sulfuric acid, a hydrochloric acid, a nitric acid, or a combination thereof.

7. The method of claim 1, wherein the immersing is performed for 10 to 30 days.

8. The method of claim 1, wherein the regular intervals are 24 hours.

9. The method of claim 1, wherein the analysis is performed by comparing contents of components from the thermal spray coated sample among the components of the acid solution measured by the ICP analysis method.

10. A method for evaluating corrosion resistance of a thermal spray coating, the method comprising:
forming a thermal spray coating of a thickness of 10 to 3000 μm on a sample to form a thermal spray coated sample;
masking non-coated regions of the sample with a masking material that is resistant to an acid solution;
immersing the thermal spray coated sample in the acid solution;
collecting samples from the acid solution at regular intervals;
analyzing the collected samples to determine type and amount of components of the thermal spray coated sample in the acid solution using an ICP analysis, and
evaluating corrosion resistance of the thermal spray coating.
